(19) United States
(12) Patent Application Publication
(10) Pub. No.: US 2011/0223417 A1
(43) Pub. Date: Sep. 15, 2011

(54) WOOD-METAL COMPOSITE STRUCTURE

(75) Inventors: Samantha Kiljunen, Lappeenranta (FI); Milla Hintikka, Lahti (FI); Raija Rautiainen, Lahti (FI); Mizanur Bulbul, Lahti (FI); Juhara Liimatainen, Savitaipale (FI)

(73) Assignee: UPM-Kymmene Wood Oy, Lahti (FI)

(21) Appl. No.: 13/120,492

(22) PCT Filed: Aug. 17, 2009
(86) PCT No.: PCT/FI2009/050664

§ 371 Date: Mar. 23, 2011

(30) Foreign Application Priority Data
Sep. 23, 2008 (FI) 20085899

(51) Int. Cl. B32B 21/08; B32B 7/04; B32B 15/085

(52) U.S. Cl. 428/344; 428/457; 428/461

(57) ABSTRACT

The invention relates to a wood-metal composite structure comprising a wood material and a metal material, and the wood material and the metal material (2) are joined together by a coupling agent. In accordance with the invention the wood-metal composite structure (5) comprises a coupling material (1,2,3,4) containing metal material (2), and the coupling material comprises at least three layers, and at least outer layers (1,3) of the coupling material contain polymer and coupling agent which is reactive with —OH groups of the materials for forming self-adhesive properties and at least one layer (2) including metal material is arranged between outer layers (1,3).

### FIELD OF THE INVENTION

The invention relates to a wood-metal composite structure as defined in the preamble of claim 1.

### BACKGROUND OF THE INVENTION

Known from prior art are various composite structures. The most typical are polyester and glass fiber composites and epoxy and carbon fiber composites. It is known to use fibers, which have a higher modulus of elasticity than the polymer. Fibers also have a large contact surface to the polymer. These kinds of composites are used more and more in airplanes, cars and other vehicles, where high strength and light weight is needed. Sport equipment is also a good example of these kinds of construction.

Known from prior art are various wood boards, e.g. plywoods, veneer boards or the like.

The plywood is another kind of composite, where wood orientation and un-continuation points are compensated by putting veneer layers to the cross-position in relation to the other veneers. In the plywood the glue line has the main property to keep plies together.

The plywood has often properties which are non-desirable, like warping and twisting. Also the normal plywood does not allow water vapor diffusion through. Then its flatness deteriorates because of the different moisture contents in different sides of the panel.

Known from U.S. Pat. No. 5,243,126, JP 2000202810 and U.S. Pat. No. 3,620,878 are different wood panels which comprise metal material.

### OBJECTIVE OF THE INVENTION

The objective of the invention is to disclose a new type of the wood-metal composite structure using a new type of solution.

### SUMMARY OF THE INVENTION

A wood-metal composite structure according to the invention is characterized by what is presented in the claims.

The invention is based on a wood-metal composite structure comprising a wood material and a metal material, and the wood material and the metal material are joined together by a coupling agent. In accordance with the invention the wood-metal composite structure comprises a coupling material containing metal material, and the coupling material comprises at least three layers, and at least outer layers of the coupling material contain polymer and coupling agent which is reactive with —OH groups of the materials, such as wood and metal, for forming self-adhesive properties and at least one layer including metal material is arranged between outer layers.

The invention is specifically based on the wood-metal composite structure having completely new properties and applications. The wood-metal composite of the invention is made with the new joining method, which is wood—coupling material—metal material. The materials of the wood-metal composite structure are substantially joined together by coupling agent being reactive with —OH groups, and in one embodiment —O groups, of the materials, preferably via esterification, for forming self-adhesive properties, preferably e.g. by maleic anhydride polyolefin.

In one embodiment of the invention the coupling agent is selected from the group: grafted silanes, grafted isocyanates, grafted epoxy groups and maleic anhydride polyolefin, e.g. maleic anhydride grafted polypropylene (MAPP), maleic anhydride grafted copolymer and maleic anhydride grafted polyethylene (MAPE). Preferably the coupling agent forms covalent bonds, ester bonds and/or covalent bonds via esterification with celluloses and/or metals —OH groups or —O groups. In one embodiment the coupling agent forms covalent bonds via esterification with materials —OH groups.

In one embodiment the coupling material contains the coupling agent and furthermore polymer e.g. polyethylene or polypropylene. Further, the coupling material can contain additives and/or fillers.

In one embodiment the coupling material includes maleic anhydride polyolefin, e.g. MAPE or MAPP, as a coupling agent and polyethylene or polypropylene. Maleic anhydride forms covalent bonds, preferably covalent bonds via esterification, with celluloses and/or metals —OH groups or —O groups.

In one embodiment the coupling material contains polymer, polyolefin, organic silane and/or titanate. In one embodiment the coupling material or polyolefin of the coupling material is grafted with alkoxysilane containing reactive functional groups with the polyolefin. In one embodiment the polyolefin is grafted with hydrolysable vinyl-mono-, -di- or -tri-alkoxysilane. In one embodiment vinyl group can be replaced with isosyanate- or epoxy groups. Alkoxysilanes alcohol groups can be methyl-, ethyl-, propyl- or isopropyl-groups and silane can contain 1, 2 or 3 alkoxy-groups. The reaction with polyolefin with the vinyl or other reactive groups happens already during the manufacturing of the coupling material, and reaction with wood by silane-groups during or after the manufacturing of the wood board.

In one embodiment of the invention the coupling agent is activated at temperatures of more than 180° C. during the coupling material manufacturing, preferably during the film manufacturing. The film and the coupling material can be manufactured by co-extrusion. Also other extrusion methods are possible. The extrusion temperature is between 180-200° C. In a preferred embodiment an extrusion melt temperature of 200° C. for 2 minutes is employed, which is sufficient time to convert the coupling agent to a reactive form. The coupling agent formed contains activated functional groups capable of forming the maximum number of covalent and/or ester bonds with —OH groups of the material. The melt index of the polyolefin being ≦4 g/10 min (measured 190° C./2.16 kg) makes the activation of the reactive groups possible in film form.

Preferably, in one embodiment maleic acid is converted to maleic anhydride during the coupling material manufacturing, preferably during the film manufacturing, (FIG. 5). The material can be manufactured by co-extrusion of the polyolefin and maleic anhydride grafted polyolefin. Also other extrusion methods are possible. The extrusion temperature is between 180-200° C. In a preferred embodiment an extrusion melt temperature of 200° C. for 2 minutes is employed, which is sufficient time to convert the coupling agent from maleic acid to maleic anhydride. The material formed contains activated functional groups capable of forming the maximum number of covalent bonds with —OH groups of the material. In one embodiment maleic anhydride conversion is more than 86% and unconverted maleic acid conversion is less than 14% in the film, in the layer of the film or in layer of the coupling material containing the maleic anhydride polyolefin. In one preferred embodiment maleic anhydride conversion is more than 92% and unconverted maleic acid conversion is less than 8%.

Also other extrusion methods are possible such as cast film extrusion in the manufacturing the coupling material.

In one embodiment of the invention the metal material comprises a metal sensor, metal antenna, metal laminate, metal sheet, metal film, metal frame or metal structure. In one embodiment the metal material contains metal formed of aluminium, steel, stainless steel, copper or their derivates or their combinations. In one embodiment the metal material comprises an RFID-identifier like an RFID-antenna or RFID-sensor, EMFI-sensor or temperature, pH, EMS or humidity sensor.

Further, in a preferred embodiment, the metal material layer contains polyolefin, e.g. polyethylene, polypropylene, coupling agent and/or metallocene produced polyethylene which is preferably a support material of the metal material layer.

In one embodiment the surface of the metal material is oxygenated. Preferably, the contact surface of the metal material is oxidized before the attachment of the metal material to the coupling material. The attachment of the metal material to the coupling material is made by chemical bonding, e.g. by covalent bonds via esterification, of the coupling agent with the —OH groups, or in one embodiment —O groups, of the oxide layer of the metal surface.

In one embodiment steel and copper are preferably surface treated with HNO₃, H₂O₂ or O₃ to form an oxide layer for the coupling of coupling agent. Aluminium and stainless steel form naturally their own oxide layer.

In one embodiment the metal surfaces are treated with a primer containing organosilane, silicone, corrosion inhibitors or their combinations to further enhance adhesion between coupling agent and the metal surfaces and also to form a corrosion barrier between the metal oxide surface and the coupling material.

In one embodiment the metal surfaces are etched, e.g. anodizing, phosphoric acid or chromic acid, in order to protect the metal oxide from moisture induced hydrolysis.

In one embodiment the metal surfaces are sanded or grinded to aid in adhesion of the primer or coupling material.

In one embodiment of the invention the layer of the coupling material containing the coupling agent is formed of a film. In one embodiment the layer of the coupling material containing the coupling agent is formed of at least a 2-layer film. In one embodiment the layer of the coupling material containing the coupling agent is formed of at least a 3-layer film. In one embodiment the layer of the coupling material containing the coupling agent is formed of at least a multi-layer film.

In one embodiment of the invention the coupling material comprises at least two layers containing the metal material. In one embodiment the coupling material comprises at least one middle layer containing polymer and coupling agent which is reactive with —OH and —O groups of the material, and the middle layer is arranged between two metal material containing layers.

Preferably all the layers of the coupling material are joined together by means of the coupling agent.

In one embodiment the layer of the coupling material containing the coupling agent, the film and/or the film layer contains polyethylene (PE), polypropylene (PP), coupling agent, metallocene produced polyethylene (TIE) and/or derivates thereof or their combinations. The layer of the coupling material containing the coupling agent, the film and/or the film layer can include additives and fillers. In a preferred embodiment the TIE-material includes maleated polyolefin.

In a preferred embodiment the layer of the coupling material containing the coupling agent, the film and/or the film layer includes maleic anhydride polyolefin e.g. maleic anhydride polyethylene (MAPE) and/or maleic anhydride polypropylene (MAPP), and further polyolefin e.g. polyethylene and/or polypropylene. In a preferred embodiment the film or the film layer which includes maleated polyolefin also contains polymer e.g. PE or PP. Preferably, the film layer including maleated polyolefin essentially consists of MAPE+PE or MAPP+PP. In one embodiment the film contains 2-15% w/w maleic anhydride. The maleated polyolefin is easy to use as the coupling agent. The maleic anhydride forms covalent bonds between materials.

In a preferred embodiment the film is a self adhesive film. The self-adhesive film is provided by coupling agent which reacts with —OH groups in other material e.g. wood or metal.

In one embodiment of the invention at least the outer surfaces of the coupling material include coupling agent. In one embodiment at least one film layer contains coupling agent. In one embodiment the outer film layers of the film contains coupling agent. In one embodiment all the film layers contain coupling agent.

The layers of the coupling material can be made from petrochemical and renewable feedstock materials. In addition bioplastic material, preferably the bio-based polymers having processing temperature over 180° C. or over 190° C., can be used.

In one embodiment, all film layers of the said coupling material are substantially formed of the same material. In an alternative embodiment, at least one film layer is formed of a different material than the other films layers.

In one embodiment of the invention the wood material is a wood board.

In this context, a wood board refers to any wood panel product, plywood product, composite product, beam, pressed panel product or the like, formed of a number of layers, preferably veneer layers, and principally of wood-based materials, in which the layers are laid one upon the other and glued together. Further, a wood board refers to any wood product or fiber product. In this context, a veneer layer refers to any layer of material, typically a thin layer of material.

A wood board according to the invention can comprise veneer layers of different thickness. The thicknesses of the veneer layers can vary. The veneer layers can be arranged in the desired position, i.e. crosswise or lengthwise in the desired order.

The wood board can be made using apparatuses and methods known per se. Laying the veneers one upon the other, joining them together and other typical steps in making the wood board can be performed in any manner known per se in the art.

In one embodiment the veneers of the wood board is glued together with phenolic glue or other conventional glue or with a coupling material. For example, the coupling material containing maleated polyolefin is easy to use as a glue line material. Adhesion to the wood is excellent. The maleated polymers at concentrations used in the films are cheap and nontoxic and they form chemical bonds that are less susceptible to hydrolysis.

In one embodiment the wood-metal composite structure comprises reinforcement fibers.

In one embodiment, the metal material layer is formed by co-extruding the metal material into the support polymer.

In one embodiment the metal material layer is arranged in conjunction with the coupling material during the manufacturing of the coupling material (FIG. 5). In one embodiment the metal material layer is arranged in conjunction with the middle layer of the coupling material e.g. beside the middle film of the coupling material. In one embodiment the metal material layer is arranged between the first and the middle layers or films. In one embodiment the metal material layer is arranged between the middle and the third layers or films. In one embodiment the metal material layer is arranged between two middle layers or films. The metal material layer is arranged between the film layers for providing a protected metal material layer. The composite structure can comprise more than one metal material layer.

In one embodiment of the invention the coupling material and the metal material is arranged inside the wood board. Preferably the metal material is arranged with the coupling material between the veneers of the wood board. In one embodiment the metal material is arranged between the films of the coupling material. In a preferred embodiment the metal material-coupling material combination is used as a glue line material.

In one embodiment of the invention the coupling material and the metal material is arranged on the surface of the wood board. In one embodiment the wood material containing the coupling material is arranged onto the surface of the metal frame or the metal structure. In one embodiment the metal material with the coupling material is arranged as a coating onto the surface of the wood board.

Preferably by the coupling agent the metal material can be attached strongly to the wood material (FIG. 5). Then the metal—coupling material—wood composite structures can be provided in a simple and efficient way. In one embodiment the films of the coupling material including the coupling agent is pressed between or onto the wood material/veneer at temperature about 140° C. The structure has a bond strength of up to 32 MPa to the oxygenated metal surface.

The gluing of the metal material to the wood material with MAPE or MAPP including coupling agent can be made at temperatures of 120-170° C., preferable at about 140° C. It is important in order to induce enough plastic melt flow that the hot-pressing temperature is set to a temperature 20-50° C. above the melting temperature of the polymer.

A compatibilizing agent can be added to any film or the metal material in order to adhere the dissimilar polymers to each other.

Arranging the coupling material in conjunction with the wood material can be performed e.g. using the hot pressing technique, extruder technique, film technique, roll application technique, cylinder application technique, coat and multi-layer coat application technique, all known per se, their combinations or a corresponding technique.

In one embodiment the co-extruded polymer films and metal can be pre-laminated to make handling easier and more economical.

By the invention it is provided wood composites which are heat and wear resistant. By the metal sheets, the warping of the panel can be decreased. The metal sheets protect soft wood against wearing at high point loads.

The wood-metal composite structure in accordance with the invention is suitable for various applications.

Metal faced board can be used as solar panel reflectors with an aluminum surface. For roofing purposes the composite with the copper surface is excellent. In all applications the metal surface provides an excellent humidity and gas barrier, e.g. to the applications of cool transport or frozen/cold storages.

A Farady's cage or EMS-panel is easy to build with metal faced board panels. In cases where metal faced panels are used to form larger surfaces than one single panel, they can be formed in a proper way of the invention. T-form metal joints can be provided by MAPE-sheets. The joining can be made at temperature under 140° C. and pressing it at the same time. The sides of the panels can be protected with an L-, Γ-form part, where the inner surface is a press-rolled MAPE-film.

Further, the wood-metal composite structures of the invention can be used in furniture, vehicle, airplane and other construction applications.

### LIST OF FIGURES

In the following, the invention is described by means of detailed embodiment examples with reference to accompanying FIGS. 1, 2a, 2b, 3, 4, 5 and 6 in which

FIGS. 1, 2a, 2b, 3 and 4 show wood-metal composite applications according to the invention,

FIG. 5 shows a schematical diagram of the chemical reaction in which maleic acid is converted to maleic anhydride and the chemical reaction in which maleic anhydride reacts with hydroxide groups of the wood and metal oxides, and

FIG. 6 shows the ATR spectroscopy results.

### DETAILED DESCRIPTION OF THE INVENTION

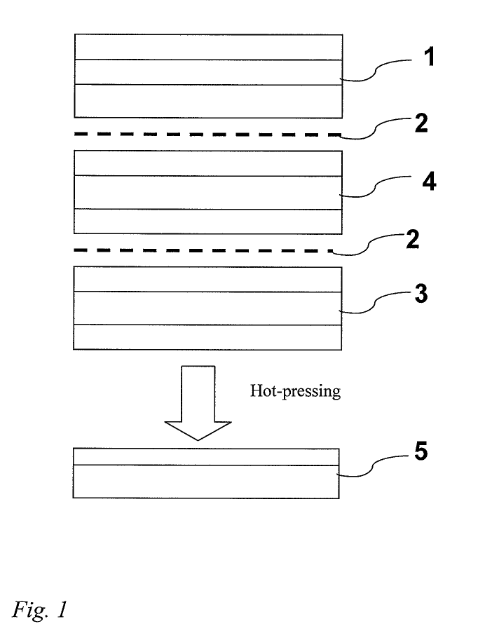

FIGS. 1-4 disclose various wood-metal composites of the invention.

FIG. 1 discloses a metal coating of the invention for a wood board (5). The coating comprises a top layer (1), a middle layer (4), a bottom layer (3) and two metal material layers (2). The first metal material layer (2) is arranged between the top and the middle layer. The second metal material layer (2) is arranged between the middle and the bottom layer. The combination of the middle layer (4) and the metal material layer (2) can consist of 3-9 alternating layers of layers (2) and (4).

A top layer (1) is formed of a 3-layer film which is PE/PE/MAPE+PE, PE/MAPE+PE/MAPE+PE, MAPE+PE/PE/MAPE+PE, MAPE+PE/MAPE+PE/MAPE+PE, PP/PP/MAPP+PP, PP/MAPP+PP/MAPP+PP, MAPP+PP/PP/MAPP+PP, MAPP+PP/MAPP+PP/MAPP+PP, PP/TIE/MAPE+PE, PET/PE+MAPE/MAPE+PE, PA/PE+MAPE/MAPE+PE, PPO/PE+MAPE/MAPE+PE or MAPP+PP/TIE/MAPE+PE. The thickness of the top layer is 0.05-0.3 mm. At least the outer film layers of the film contain maleated polymer.

A middle layer (4) is formed of a 3-layer film which is MAPE+PE/PE/MAPE+PE, MAPE+PE/MAPE+PE/MAPE+PE, MAPP+PP/PP/MAPP+PP or MAPP+PP/MAPP+PP/MAPP+PP. The thickness of the top layer is 0.05-1 mm. At least the outer film layers of the film contain maleated polymer.

Two metal material layers (2) are formed of metal material e.g aluminium, steel, stainless steel and/or copper. Further, the metal material layers include polymer e.g. PE, PP, MAPE, MAPP and/or TIE. The metal material layers are attached to the outer surfaces of the middle layer. The thickness of the metal material layer is about 0.1-0.3 mm.

A bottom layer (3) is formed of a 3-layer film which is MAPE+PE/PE/MAPE+PE, MAPE+PE/MAPE+PE/MAPE+PE, MAPP+PP/PP/MAPP+PP or MAPP+PP/MAPP+PP/MAPP+PP. The thickness of the bottom layer is 0.05-0.3 mm. At least the outer film layers of the film contain maleated polymer.

The middle layer (4) is sandwiched between the top layer (1) and the bottom layer (3). All these layers are self adhesive films and include maleic anhydride polyolefins like MAPE and/or MAPP. The film layer can include additives and/or fillers. Further, the film layer can be pigmented, painted or printed.

As the wood board can be used plywood, particle board, high or middle density fiberboard, or some other pressed and glued board containing wood or other plant fibers. The veneers of the wood board can be glued together with phenolic glue or other conventional glue or with a polymer film including maleated polyolefin.

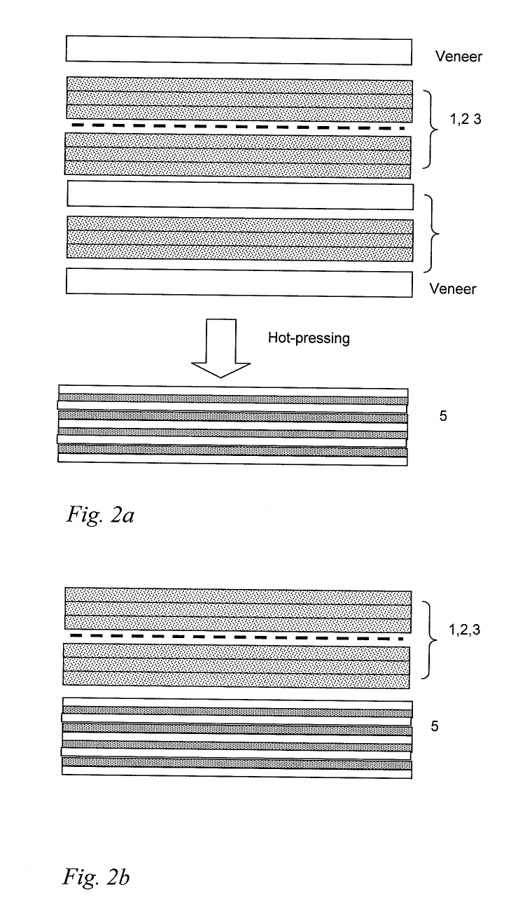

FIG. 2a discloses a metal material layer arranged between the veneers inside the wood board. In this case the metal material layer is used as a glue line between the veneers.

The metal material layer is formed of a metal sensor and 3-layer polymer films. The metal sensor is arranged between the polymer films. The polymer film is formed of MAPE/PE/MAPE, MAPE/MAPE/MAPE, MAPP/PP/MAPP, MAPP/MAPP/MAPP or MAPP/TIE/MAPE in which at least the outer film layers of the film contain maleated polymer. The thickness of the film is 0.05-0.3 mm. The metal sensor is formed of an RFID-sensor or RFID-antenna.

FIG. 2b discloses a metal material coating arranged on the surface of the wood board.

The metal material coating is formed of a metal sensor and 3-layer polymer films. The metal sensor is arranged between the polymer films. The polymer film is formed of MAPE/PE/MAPE, MAPE/MAPE/MAPE, MAPP/PP/MAPP, MAPP/MAPP/MAPP or MAPP/TIE/MAPE in which at least the outer film layers of the film contain maleated polymer. The thickness of the film is 0.05-0.3 mm. The metal sensor is formed of RFID-sensor or RFID-antenna.

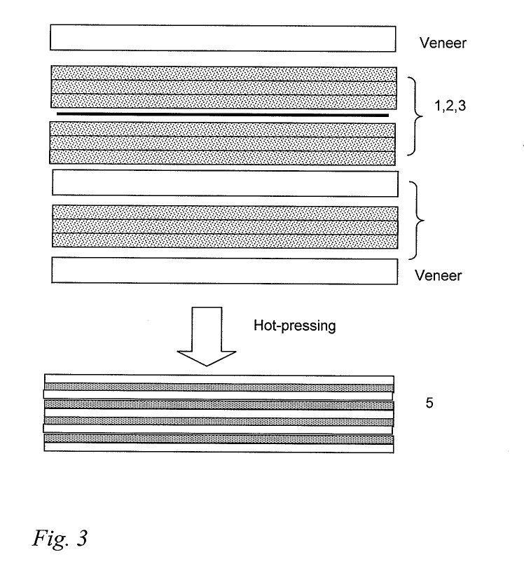

FIG. 3 discloses a metal material layer arranged between the veneers inside the wood board. In this case the metal material layer is used as a glue line between the veneers.

The metal material layer is formed of a metal laminate and 3-layer polymer films. The metal laminate is arranged between the polymer films. The polymer film is formed of MAPE/PE/MAPE, MAPE/MAPE/MAPE, MAPP/PP/MAPP, MAPP/MAPP/MAPP or MAPP/TIE/MAPE in which at least the outer film layers of the film contain maleated polymer. The thickness of the film is 0.05-0.3 mm. The metal laminate is formed of metal sheet. The thickness of the metal laminate is 0.05-1 mm.

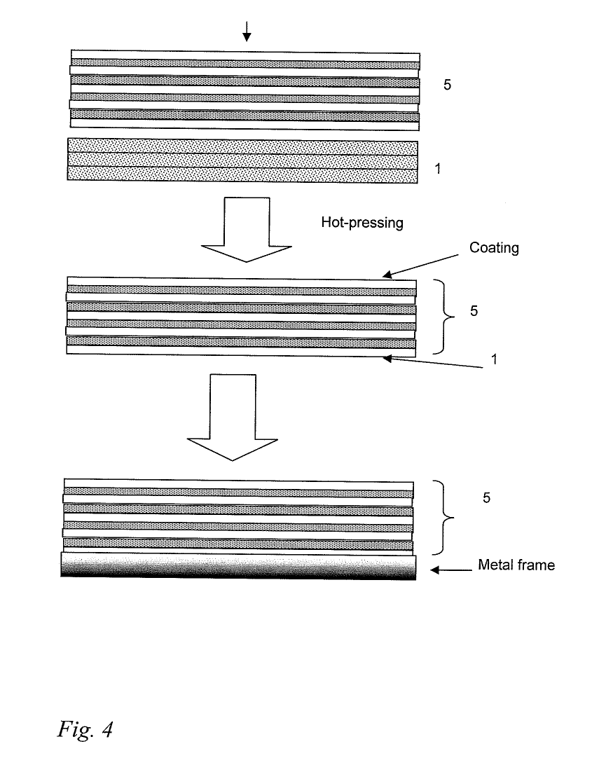

FIG. 4 discloses the forming of the wood-metal composite structure comprising a wood board, a polymer film and a metal frame. The 3-layer polymer film is formed of MAPE/PE/MAPE, MAPE/MAPE/MAPE, MAPP/PP/MAPP, MAPP/MAPP/MAPP or MAPP/TIE/MAPE in which at least the outer film layers of the film contain maleated polymer. The thickness of the film is 0.05-0.3 mm. The polymer film is arranged underside the wood board. In this case the polymer film is used as a glue line between the wood board and the metal frame. The adhesive layer of the polymer film including maleated polyolefin is re-heated before attachment of the wood board-polymer film structure onto the metal frame.

From the tests it was discovered that the composites of the invention are suitable wood-metal composite structures to be used as various applications.

### Example 1

In this example, the wood-metal composite structure of the invention and the metal materials were tested.

Table 1 shows the test results of the coating comprising aluminum and temperature sensitive self-adhesive film to plywood in order to improve the bending properties. Table 1 shows cross-linking dosage, tensile strength (EN789) and modulus of elasticity (MOE) of the modified thermoplastic films. The MOE was calculated from 10-40% of the maximum force. The cross-head distance was 10 mm and sample size 50×250 mm. The temperature sensitive self-adhesive films were 0.27 mm and 0.03 mm thick (specified in Table 1) of construction 2% MAPE+MI-0.3PE/MI−0.3PE/2% MAPE+MI−0.3PE. The aluminium was 0.03 mm thick. The coating was bonded to 15 mm un-sanded birch plywood by hot-pressing in which parameters were: 1.6 N/mm², 140° C. temperature and 480 sec. The radiation sensitive film had much better tensile strength properties after radiation. Cross-linking of polyethylene by radiation treatment appeared to damage slightly the mechanical properties of the films. The polymer density, which was to be expected, had a significant effect on the stiffness of the polymer.

TABLE 1

| | Cross- | | | | | |
|---|---|---|---|---|---|---|
| | linking | | Mechanical properties | | | |
| | dosage | | MOE | | Tensile strength | |
| Middle reinforcement material | (kGy) | | (N/mm²) | | (N/mm²) | |
| 2% MAPE + MI − 0.3 PE/MI − | 150 | (100) | 437.1 | (416.8) | 13.6 | (13.0) |
| 0.5 HDPE/2% MAPE + MI − 0.3 PE | | | | | | |
| (radiation sensitive HDPE ) | | | | | | |
| 2% MAPE + MI − 0.3 PE/MI − | 200 | | 374.9 | | 13.0 | |
| 0.2 HDPE/2% MAPE + MI − 0.3 PE | | | | | | |
| 2% MAPE + MI − 0.3 PE/MI − | 200 | | 285.9 | | 10.3 | |
| 0.4 MDPE/2% MAPE + MI − 0.3 PE | | | | | | |
| 2% MAPE + MI − 0.3 PE/MI − | 150 | | 191.6 | | 8.6 | |
| 0.3 PE/2% MAPE + MI − 0.3 PE | | | | | | |

| | | | |
|---|---|---|---|
| 2% MAPE + MI − 0.3 PE/MI − | — | 291.4 | 10.5 |
| 0.4 MDPE/2% MAPE + MI − 0.3 PE | | | |
| 2% MAPE + MI − 0.3 PE/MI − | — | 357.2 | 11.3 |
| 0.2 HDPE/2% MAPE + MI − 0.3 PE | | | |
| 2% MAPE + MI − 0.3 PE/MI − | — | 191.9 | 8.4 |
| 0.3 PE/2% MAPE + MI − 0.3 PE | | | |
| 3% MAPE + MI − 0.2 HDPE/MI − | — | 926.6 | 21.4 |
| 0.2 HDPE/3% MAPE + MI − 0.2 HDPE | | | |

MI is the melt index of a polymer. It is a measure of the melt viscosity, but it is the inverse of real viscosity.

Table 2 shows the results of adhesion strength and breakage point and boiling test between different metals specified in Table 2 and the temperature sensitive self-adhesive plastic films to create new types of coatings. The temperature sensitive self-adhesive films were 0.27 mm thick of construction 2% MAPE+MI-0.3PE/MI-0.3PE/2% MAPE+MI-0.3PE. The aluminium was 0.03 mm thick. The coating was bonded to 15 mm un-sanded birch plywood by hot-pressing in which parameters were: 1.6 N/mm², 140° C. temperature and 480 sec. Nitric acid (30%) was used to oxidize the metal surface. It was clear that aluminum with or without oxidation formed a very good bond. However, generally bonding was better if the metal surface was oxidized. Copper showed poor adhesion before and after oxidation of the surface. The green oxide formed was not so reactive with maleic anhydride. Therefore, lower concentration of nitric acid was required to prevent the oxide converting to the green form.

TABLE 2

| | | Acid and sanding | | | | | | |
|---|---|---|---|---|---|---|---|---|
| | Metal | Oxidised | Visual | Mape X | Fmax (N) | (N/mm²) | Breakage | Boiling test |
| 1 | Cu | X | Green | 1 | 412 | 0.16 | Between | — |
| | | | | | | | film and | |
| | | | | | | | metal | |
| 2 | Cu | X | Green | 3 | — | | Break | — |
| | | | | | | | before | |
| | | | | | | | test | |
| 3 | Br | X | | 1 | 4828 | 1.93 | Break in | Failed |
| | | | | | | | plywood | |
| 4 | Br | X | | 3 | — | | Break | Passed |
| | | | | | | | before | |
| | | | | | | | test | |
| 5 | Sts | X | | 1 | 5386 | 2.15 | Break in | Passed |
| | | | | | | | plywood | |
| 6 | Sts | X | | 3 | 3071 | 1.23 | Break in | Passed |
| | | | | | | | plywood | |
| 7 | Al | X | | 1 | 4276 | 1.71 | Break in | Passed |
| | | | | | | | plywood | |
| 8 | Al | X | | 3 | 4487 | 1.79 | Break in | Passed |
| | | | | | | | plywood | |
| 9 | Al | X | | 1 | 5084 | 2.03 | Break in | Passed |
| | | | | | | | plywood | |
| 10 | Al | X | | 3 | 5091 | 2.04 | Break in | Passed |
| | | | | | | | plywood | |
| 11 | Al | — | | 3 | 4877 | 1.95 | Break in | Passed |
| | | | | | | | plywood | |

Table 3 shows the adhesion results of the films to the metal and wood and failure results in the plywood for both dry conditions and after soaking. 0.03 mm aluminum foil was joint to un-sanded 15 mm plywood with 0.27 mm film comprising 2% MAPE+PE/PE/2% MAPE+PE by hot-pressing in which parameters were: 1.6 N/mm², 140° C. temperature and 480 sec. This shows that the coupling agent covalently bonds with the metal. If a hydrogen bond is formed then this will be susceptible to hydrolysis and failure after soaking would be observed between the maleic anhydride modified film and aluminum.

TABLE 3

| | Testing | Wood | Strength |
|---|---|---|---|
| Condition | location | breakage % | (N/mm²) |
| Dry conditions | Joint between | 100 | 5.2 |
| | aluminium and | | |
| | plywood | | |
| After soaking | Joint between | 97 | 2.2 |
| | aluminium and | | |
| | plywood | | |

Table 4 shows the results for RFID bonded with temperature sensitive self adhesive films at different locations in the plywood. The films were bonded directly to the metal RFID or to an alternative RFID substrate. The films were 0.27 mm thick of construction 2% MAPE+PE/PE/2% MAPE+PE and the films was bonded to 15 mm plywood. In the case of HDPE adhesion to the substrate was excellent. Adhesion to all the metals was very good but adhesion to paper was only moderate and to polyester adhesion was poor. In addition to this all RFID worked after hot-pressing no matter where in the plywood the tag was placed or to what substrate it was bonded to.

TABLE 4

| | | Adhesion to maleic | |
|---|---|---|---|
| | Tag location | anhydride film | |
| Substrate/metal | in the panel | Metal | Tag substrate |
| HDPE/ HDPE | Middle | — | Excellent |
| Paper/aluminum | Middle | Excellent | Moderate |
| Polyester/silver | Middle | Excellent | Poor |
| HDPE/HDPE | Under surface | — | Excellent |
| | veneer | | |
| Paper/aluminum | Under surface | Excellent | Moderate |
| | veneer | | |
| Polyester/silver | Under surface | Excellent | Poor |
| | veneer | | |

### Example 2

In this example, stability of the wood-metal composite structure of the invention was tested.

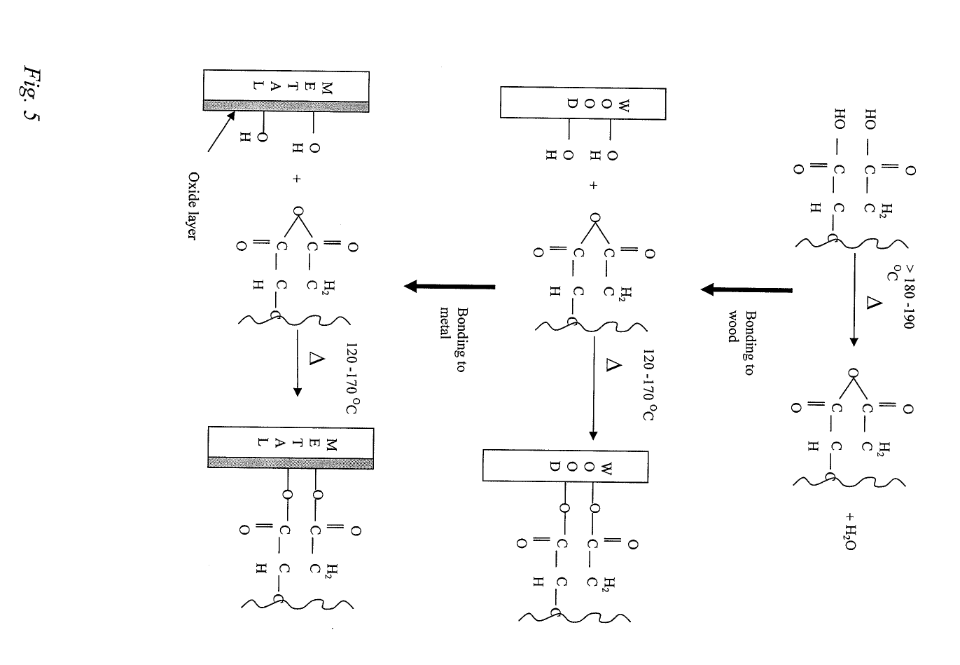

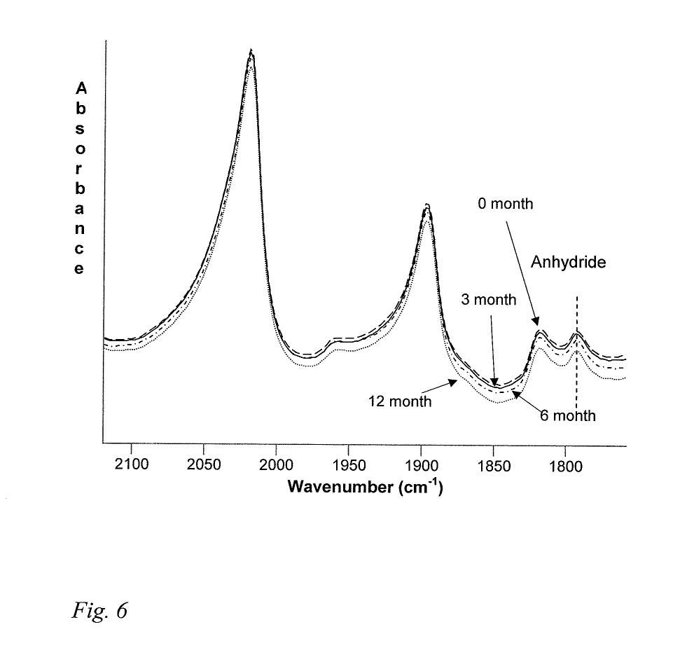

Tables 5 to 7 and FIGS. 5 to 6 show the conversion of maleic acid to maleic anhydride and its affect on the glue-line strength and the stability of the films after maleic anhydride is converted to the active state and contact angles of the polar groups face inwards.

Table 5 and FIG. 5 show the conversion to maleic anhydride during film manufacturing of maleic anhydride grafted polyethylene (Fusabond MB-226DE) film 2% MAPE+PE/PE/2% MAPE+PE at different extrusion temperatures.

TABLE 5

| | | | | Coating glue-line | |
|---|---|---|---|---|---|
| Treatment | Treatment | Maleic | Maleic | strength N/mm² | |
| temperature | time | acid | anhydride | (wood failure %) | |
| (° C.) | (minutes) | (%) | (%) | After boiling | |
| No | 3 | 55 | 45 | — | |
| treatment | | | | | |
| 170 | 3 | 36 | 64 | 0.17 | (0%) |
| 180 | 3 | 20 | 80 | 0.31 | (70%) |
| 185 | 3 | 14 | 86 | 0.34 | (80-90%) |
| 190 | 3 | 10 | 90 | 0.36 | (90-100%) |
| 195 | 3 | 8 | 92 | 0.36 | (90-100%) |

It is clear from the results of Table 5 that the maleic acid is converted mostly to maleic anhydride at temperatures of 185° C. for 3 minutes and therefore it can be considered that during extrusion where the polymer is in the melt for about 2-3 minutes that an extrusion temperature of >185° C. is sufficient but preferably >190° C. The coating glue-line strength and percentage wood failure is on a similar level after boiling as for Wisa Multi-wall (0.4 N/mm², 80-90% wood failure) which also supports that conversion of maleic acid to maleic anhydride is sufficient at temperatures of >185° C.

Once the maleic acid is converted to maleic anhydride it is important to know how long the films will remain in the active state before enough moisture is absorbed and the maleic anhydride is converted back to maleic acid. Films containing the activated material were conditioned (humidity 65% and temperature 23° C.) for 1 month, 3 month, 6 month and month. The films were analysed by ATR-FTIR spectroscopy.

FIG. 6 and Table 6 show the ATR spectros-copy results comparing the maleic anhydride in the films (Table 5) extruded for 2-3 minutes at 200° C. it is clear that sufficient maleic acid is converted to maleic anhydride and therefore the extrusion temperature and processing time is sufficient. FIG. 6 shows ATR-FTIR spectra of 3 different films identified in Table 6 (45 degree Germanium ATR unit).

TABLE 6

| | Coupling | | | |
|---|---|---|---|---|
| Film | agent | Film age | | Film type |
| 2 | Fusabond | 1 | year | 2% MAPE + PE/PE/2% MAPE + PE |
| 3 | MB226DE | 6 | month | 2% MAPE + PE/PE/2% MAPE + PE |
| 4 | | 3 | month | 2% MAPE + PE/PE/2% MAPE + PE |

The results revealed no change in the amount of maleic anhydride and spectra similar to film-4 in FIG. 6 resulted after each month for a total of 12 months. This shows the maleic anhydride is stable long-term when surrounded by polyethylene. This is owing to the low water absorption of polyethylene and also to the fact in the solid state the maleic acid groups will not be at the polymer surface but facing inwards and therefore shielded. The maleic groups are only facing outwards when the polymer is in the melt. This theory of the hydrophilic groups facing inwards is supported by the contact angle results in Table 7. Table 7 shows contact angles (receded and advanced) and surface free energy measured for different activated 3-layer co-extruded films by the pendent drop method. Two test liquids were used diiodomethane (DIM) and water. The maleated polymer films were compared with other polar group (EVA) containing films.

TABLE 7

| | | 2% MAPE + | | 4% EVA + | | 8% EVA + | |
|---|---|---|---|---|---|---|---|
| | | PE/PE/ | | PE/PE/ | | PE/PE/ | |
| Film type | | 2% MAPE + PE | | 2% EVA + PE | | 8% EVA + PE | |
| Film thickness | | 0.27 | | 0.27 | | 0.27 | |
| (mm) | | | | | | | |
| Average | Advanced | 108.5 ± | 0.6 | 98.8 ± | 0.6 | 98.7 ± | 1.6 |
| water | Receded | 89.6 ± | 0.6 | 85..8 ± | 0.6 | 83.0 ± | 2.9 |
| contact | | | | | | | |
| angle | | | | | | | |
| (°) | | | | | | | |
| Average | Advanced | 57.1 ± | 1.2 | 53.8 ± | 0.6 | 49.0 ± | 1.4 |
| DIM | Receded | 46.7 ± | 0.8 | 43.4 ± | 1.1 | 43.8 ± | 1.3 |
| contact | | | | | | | |
| angle | | | | | | | |
| (°) | | | | | | | |

| Surface free | 38 | 40 | 41 |
|---|---|---|---|
| energy (mJm⁻²) | | | |

A wood-metal composite structure according to the invention is suitable in their different embodiments for different types of applications.

The embodiments of the invention are not limited to the examples presented rather many variations are possible within the scope of the accompanying claims.

1. A wood-metal composite structure comprising a wood material and a metal material, and the wood material and the metal material are joined together by a coupling agent, wherein the wood-metal composite structure comprises a coupling material containing metal material, and the coupling material comprises at least three layers, and at least outer layers of the coupling material contain polymer and coupling agent which is reactive with —OH groups of the materials for forming self-adhesive properties and at least one layer including metal material is arranged between outer layers.

2. The composite structure according to claim 1, wherein the metal material comprises metal sensor, metal antenna, metal laminate, metal sheet, metal film, metal frame or metal structure.

3. The composite structure according to claim 1, wherein the metal material contains metal formed of aluminium, steel, stainless steel, copper or their derivates or their combinations.

4. The composite structure according to claim 1, wherein the surface of the metal material is oxygenated.

5. The composite structure according to claim 1, wherein the coupling agent is selected from the group maleic anhydride polyolefin.

6. The composite structure according to claim 5, wherein maleic acid is converted to maleic anhydride during the film manufacturing so that maleic anhydride conversion is more than 86% and unconverted maleic acid conversion is less than 14%.

7. The composite structure according to claim 1, wherein the layer of the coupling material containing the coupling agent is formed of a film.

8. The composite structure according to claim 7, wherein the layer of the coupling material containing the coupling agent is formed of at least a 2-layer film.

9. The composite structure according to claim 7, wherein the film is a 3-layer film.

10. The composite structure according to claim 7, wherein the film is a multi-layer film.

11. The composite structure according to claim 1, wherein the coupling material comprises at least two layers containing the metal material.

12. The composite structure according to claim 11, wherein the coupling material comprises at least one middle layer containing polymer and coupling agent, and the middle layer is arranged between two metal material containing layers.

13. The composite structure according to claim 1, wherein the coupling material is manufactured by co-extrusion and the coupling agent is activated at temperatures of more than 180° C. during the coupling material manufacturing.

14. The composite structure according to claim 1, wherein the wood material is a wood board.

15. The composite structure according to claim 1, wherein the coupling material is arranged inside the wood board.

16. The composite structure according to claim 1, wherein the coupling material is arranged on the surface of the wood board.
